(19) United States
(12) Patent Application Publication
(10) Pub. No.: US 2026/0167475 A1
(43) Pub. Date: Jun. 18, 2026

(54) ELECTRIC LIFTING DEVICE

(71) Applicants: INTRADIN (HUZHOU) INTELLIGENT TECHNOLOGY CO., LTD., Huzhou (CN); GREAT CIRCLE MACHINERY CORP, ONTARIO, CA (US)

(72) Inventors: Junliang WANG, Huzhou (CN); Xiaobo XU, Huzhou (CN)

(21) Appl. No.: 19/533,884

(22) Filed: Feb. 9, 2026

(30) Foreign Application Priority Data
Oct. 17, 2025 (CN) 202511490660.7

(51) Int. Cl. B66F 9/18; B66F 9/24

(52) U.S. Cl. CPC B66F 9/186; B66F 9/24

(57) ABSTRACT

An electric lifting device, including a base, a support column, a sliding frame, a lifting arm, an auxiliary frame, a transmission assembly and a driving assembly. The support column has a hollow structure, and is mounted on the base. A side of the support column is provided with a sliding groove extending along a length direction of the support column. The sliding groove communicates with an interior of the support column. The sliding frame slides along the sliding groove. A connecting part is mounted on a side of the sliding frame away from the support column. The lifting arm and the auxiliary frame are mounted on the connecting part. The auxiliary frame is provided with an extendable hanging pin. The transmission assembly is provided within the support column. The driving assembly drives the sliding frame to move along the sliding groove via the transmission assembly.

### CROSS-REFERENCE TO RELATED APPLICATIONS

This application claims the benefit of priority from Chinese Patent Application No. 202511490660.7, filed on Oct. 17, 2025. The content of the aforementioned application, including any intervening amendments made thereto, is incorporated herein by reference in its entirety.

### TECHNICAL FIELD

This application relates to lifting machines, and more particularly to an electric lifting device.

### BACKGROUND

In the scenarios of handling or transferring paint buckets, when the paint buckets are stacked in multiple layers, the upper paint bucket generally lack the forklift fixation, and thus needs to be hooked to prevent it from falling during transportation.

In the prior art, although the dimensions of commercially-available plastic buckets of different standard specifications are generally fixed, dimensional deviations may occur in the paint bucket and the handle during manufacturing. When the practical dimension is lower than the preset dimension, the handle may be positioned slightly below a hook of a lifting machine, making it difficult or impossible to secure the handle onto the hook, or reducing the engagement reliability. As a result, the paint bucket may tip or fall during handling or transfer. In view of this, the present disclosure proposes an electric lifting device to solve such problems.

### SUMMARY

In view of this, an object of the disclosure is to provide an electric lifting device to overcome the defects in the prior art.

Technical solutions of the present disclosure are described as follows.

An electric lifting device, comprising:
a base;
a support column;
a sliding frame;
a lifting arm;
an auxiliary frame;
a transmission assembly; and
a driving assembly;
wherein the support column is configured to be hollow, and is vertically mounted on the base; a side of the support column is provided with a sliding groove extending along a length direction of the support column; and the sliding groove communicates with an interior of the support column;
the sliding frame is configured to be partially embedded within the sliding groove, and extend into the interior of the support column; and the sliding frame is configured to slide along the sliding groove;
the lifting arm is mounted to the sliding frame;
the auxiliary frame is mounted on the sliding frame, and is arranged parallel to the support column; the auxiliary frame is provided with a plurality of hanging pins; and the plurality of hanging pins are extendable;
the transmission assembly is provided at the support column; and
the driving assembly is provided on a side of the support column away from the lifting arm, and is configured to drive the sliding frame to slide through the transmission assembly.

In some embodiments, the auxiliary frame is provided with a plurality of cross beams arranged spaced apart from each other;
each of the plurality of hanging pins is movably inserted in a corresponding one of the plurality of cross beams, and is configured to extend through the corresponding one of the plurality of cross beams;
a middle-lower portion of each the plurality of hanging pins is located within the corresponding one of the plurality of cross beams, and is sleevedly provided with an elastic component;
a middle-upper portion of each of the plurality of hanging pins is configured to protrude from a top surface of the corresponding one of the plurality of cross beams; and
a first end of the elastic component is connected to a side wall of a corresponding one of the plurality of hanging pins, and a second end of the elastic component is connected to an inner wall of the corresponding one of the plurality of cross beams.

In some embodiments, a boss is formed at a junction between the middle-lower portion and the middle-upper portion of each of the plurality of hanging pins;
the first end of the elastic component is configured to abut against the boss, and the second end of the elastic component is configured to abut against a bottom surface of the corresponding one of the plurality of cross beams; and
a limiting part is provided at an end of each of the plurality of hanging pins located outside the bottom surface of the corresponding one of the plurality of cross beams.

In some embodiments, a side wall of the middle-upper portion of each of the plurality of hanging pins is configured to be recessed inward to form an hourglass shape.

In some embodiments, the number of the plurality of cross beams is two; the number of the plurality of hanging pins is two; two cross beams are arranged spaced apart from each other along a length direction of the auxiliary frame, and consist of a first cross beam and a second cross beam located below the first cross beam; and
a height difference between a top end of one of the two hanging pins on the second cross beam and a top surface of the lifting arm at a position below a root portion of a handle of a bucket is 510±20 mm.

In some embodiments, a height difference between a top end of one of the two hanging pins on the first cross beam and the top end of the one of the two hanging pins on the second cross beam is 355±20 mm.

In some embodiments, the transmission assembly comprises a first drive wheel, a mounting bracket, a second drive wheel, a rotating shaft, and a transmission belt;
the first drive wheel is rotatably mounted on an inner wall at an upper end of the support column through the mounting bracket;
the second drive wheel is sleevedly connected with the rotating shaft;
two ends of the rotating shaft are rotatably mounted on an inner wall at a lower end of the support column;
one of the two ends of the rotating shaft is configured to extend through the support column to be connected to the driving assembly;
the first drive wheel is drivably connected to the second drive wheel through the transmission belt; and
the transmission belt is fixedly connected to a portion of the sliding frame extending into the support column.

In some embodiments, a one-way bearing is provided between the second drive wheel and the rotating shaft.

In some embodiments, the driving assembly comprises a motor, a housing and a battery;
the motor is mounted to the support column;
an output shaft of the motor is connected to the rotating shaft;
the housing is configured to cover the motor;
the battery is engaged with an outer wall of the housing; and
the battery is electrically connected to the motor.

In some embodiments, a limit switch is provided on an inner wall of the support column adjacent to a top of the support column;
a limit contact piece is provided on a side of the sliding frame extending into the support column; and
in response to a case that the limit contact piece is in contact with the limit switch, the sliding frame is configured to be stopped from sliding toward the top of the support column.

Compared to the prior art, the present disclosure has the following beneficial effects.

Regarding the electric lifting device provided herein, the auxiliary frame is provided with the hanging pins, and the hanging pins are extendable. When the practical dimensions of a paint bucket and a handle are lower than the preset dimensions thereof, the handle may be positioned slightly below the hanging pin of the electric lifting device, making it difficult or impossible to secure the handle onto the hanging pin. At this time, the hanging pin can be extendable to accommodate the position of the handle, thereby enabling the handle to be secured to the hanging pin, or at least facilitating securing of the handle on the hanging pin.

### BRIEF DESCRIPTION OF THE DRAWINGS

In order to illustrate the technical solutions in the embodiments of the present disclosure or the prior art more clearly, the accompanying drawings needed in the description of the embodiments or prior art will be briefly described below. Obviously, presented in the accompanying drawings are only some embodiments of the present disclosure, and for those of ordinary skill in the art, other accompanying drawings can be obtained from the structures illustrated therein without making creative effort.

FIG. 1 is a three-dimensional structural diagram of an electric lifting device according to an embodiment of the present disclosure;

FIG. 2 schematically illustrates an assembly relationship between a bucket and the electric lifting device according to an embodiment of the present disclosure;

FIG. 3 schematically shows dimensional relationships between the electric lifting device and a bucket in an assembled state according to an embodiment of the present disclosure;

FIG. 4 is a side cross-sectional view of the electric lifting device according to an embodiment of the present disclosure;

FIG. 5 is an enlarged view of portion “A” in FIG. 4;

FIG. 6 is an enlarged view of portion “B” in FIG. 4;

FIG. 7 is a front cross-sectional view of the electric lifting device according to an embodiment of the present disclosure; and

FIG. 8 is an enlarged view of portion “C” in FIG. 7.

### IN THE FIGURES

1—base; 11—roller; 12—support leg; 13—swivel caster; 14—foot-operated bracket; 2—support column; 21—sliding groove; 22—second handle; 221—control button; 23—auxiliary pulley; 24—limit switch; 3—sliding frame; 31—connecting member; 32—lifting arm; 33—auxiliary frame; 331—cross beam; 332—hanging pin; 3321—boss; 333—elastic component; 334—limiting part; 34—driven wheel; 35—limit contact piece; 4—transmission assembly; 41—first drive wheel; 411—mounting bracket; 42—second drive wheel; 43—rotating shaft; 44—bearing; 45—one-way bearing; 46—transmission belt; 47—fixing clamp plate; 5—driving assembly; 51—motor; 511—output shaft; 52—housing; 53—battery; 6—bucket; 61—first handle; and 62—flange.

The implementation, functional characteristics, and advantages of the present disclosure will be further described in conjunction with the embodiments and the accompanying drawings.

### DETAILED DESCRIPTION OF EMBODIMENTS

The technical solutions of the present disclosure will be described clearly and completely below in conjunction with the accompanying drawings. It is obvious that described herein are merely some embodiments of the present disclosure, rather than all embodiments of the present disclosure. Based on the embodiments in the present disclosure, all other embodiments obtained by those of ordinary skill in the art without making creative effort shall fall within the scope of the present disclosure defined by the appended claims.

It should be noted that all directional indications (such as up, down, left, right, front, and back) in the embodiments of the present disclosure are used only for explaining the relative positional relationship or movement between the components in a particular attitude (as shown in the accompanying drawings), and the directional indications are correspondingly changed if the particular attitude is changed.

Furthermore, as used herein, terms such as “first” and “second” are only descriptive, and should not be construed as indicating or implying their relative importance or implicitly specifying the number of technical features indicated. As a result, a feature defined as “first” or “second” may include at least one of such features, either explicitly or implicitly. In addition, “and/or” includes three solutions, for example, “A and/or B” includes technical solution A, technical solution B, and a combination thereof. In addition, the technical solutions of various embodiments may be combined with each other on the premise that the combined solution can be implemented by those of ordinary skill in the art. When the combination of technical solutions appears to be contradictory or unimplementable, it should be understood that such a combination does not exist, and is not included within the scope of the present disclosure.

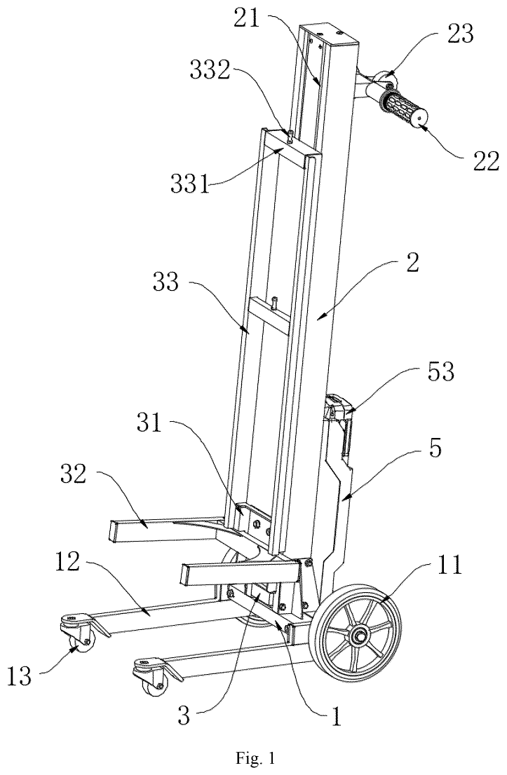

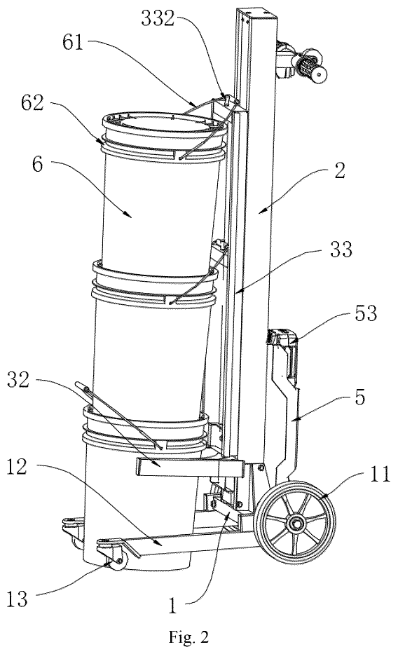

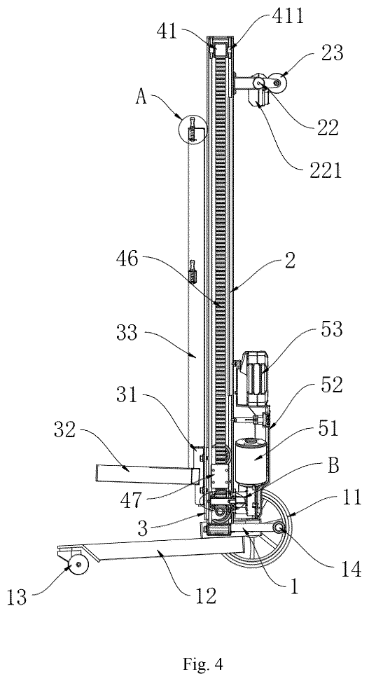

As shown in FIGS. 1-4, an embodiment of the present disclosure provides an electric lifting device, including a base 1, a support column 2, a sliding frame 3, a lifting arm 32, an auxiliary frame 33, a transmission assembly 4 and a driving assembly 5. The support column 2 is configured to be hollow, and is vertically mounted on the base 1. A side of the support column 2 is provided with a sliding groove 21 extending along a length direction of the support column 2. The sliding groove 21 communicates with an interior of the support column 2. The sliding frame 3 is configured to be partially embedded within the sliding groove 21 and extend into the interior of the support column 2. The sliding frame 3 is configured to slide along the sliding groove 21. A connecting member 31 is mounted on a side of the sliding frame 3 away from the support column 2. The lifting arm 32 is mounted to the sliding frame 3 through the connecting member 31. The auxiliary frame 33 is mounted on the sliding frame 3 through the connecting member 31, and is arranged parallel to the support column 2. The lifting arm 32 and the auxiliary frame 33 are arranged at an included angle relative to each other. The auxiliary frame 33 is provided with a plurality of cross beams 331 arranged spaced apart from each other. Each of the plurality of cross beams 331 is provided a hanging pin 332. The hanging pin 332 is extendable. The transmission assembly 4 is provided at the support column 2. The driving assembly 5 is provided on a side of the support column 2 away from the lifting arm 32, and is configured to drive the sliding frame 3 to slide through the transmission assembly 4.

In this embodiment, the number of the sliding groove 21 is two. The sliding frame 3 is configured as a plate having a U-shaped cross-section. Two sides of the sliding frame 3 are respectively inserted into two sliding grooves 21, and are configured to extend into the support column 2.

The connecting member 31 is fixedly connected to the sliding frame 3, the lifting arm 32 is fixedly connected to the connecting member 31, and the auxiliary frame 33 is fixedly connected to the connecting member 31, specifically by detachable bolt fastening or welding, thereby facilitating disassembly and replacement of the lifting arm 32 and the auxiliary frame 33, and reducing packaging volume. The included angle between the lifting arm 32 and the auxiliary frame 33 is 88°. In some embodiments, the included angle may also be set to other angles within a range of 75°-90°.By arranging the lifting arm 32 and the auxiliary frame 33 at an included angle, a bucket is arranged to be inclined toward a side the support column 2, such that the bucket 6 is more securely supported and less prone to tipping during lifting and lowering. A vertical projection of the lifting arm 32 is U-shaped, thereby forming form an embracing configuration around the bucket 6.

The number of the cross beams 331 is two. The number of the hanging pins is two. Two cross beams 331 are arranged spaced apart from each other along a length direction of the auxiliary frame 33, and consist of a first cross beam and a second cross beam located below the first cross beam. The hanging pin 332 is provided in a middle region of each cross beam 331. The hanging pin 332 can be extendable according to a size of the bucket 6, thereby improving applicability.

During operation, the lifting arm 32 is moved to two sides of the bucket 6 and abuts against a flange 62 at a top of the bucket 6. When the practical heights of the bucket 6 and a first handle 61 are lower than the preset heights thereof, the first handle 61 is positioned lower than the hanging pin 332, the first handle 61 cannot be smoothly secured to the hanging pin 332. In this case, the hanging pin 332 may be pressed downward to position the hanging pin 332 below the location of the first handle 61, thereby accommodating the deviation of the first handle 61. The hanging pin 332 then rebounds to secure the first handle 61 onto the hanging pin 332. Upon activating the driving assembly 5, the driving assembly 5 drives the sliding frame3 to move from a lower end to an upper end of the support column 2 through the transmission assembly 4, thereby moving the lifting arm 32 and the auxiliary frame 33 synchronously, so as to lift the bucket 6. During the lifting process, the hanging pin 332 limits the movement of the first handle 61 of the bucket 6 to prevent the bucket 6 from tipping or falling.

In the present disclosure, the hanging pin 332 that is extendable is provided on each cross beam 331 of the auxiliary frame 33. When the practical dimensions of the bucket 6 and the first handle 61 are lower than the preset dimensions thereof, the first handle 61 may be positioned slightly below the hanging pin 332 of the electric lifting device, making it difficult or impossible to secure the first handle 61 onto the hanging pin 332. In this case, the hanging pin 332 can be extendable to accommodate the position of the first handle 61 of the bucket 6, thereby allowing the first handle 61 to be secured to the hanging pin 332.

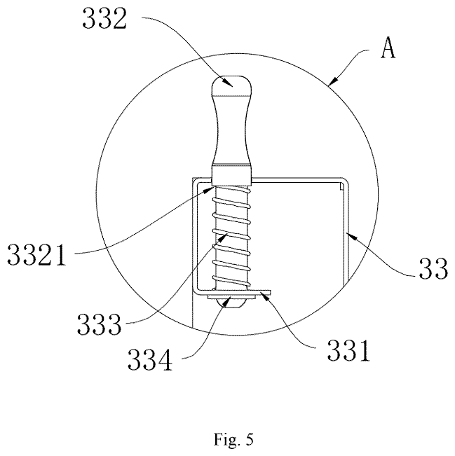

As shown in FIG. 5, in an embodiment, the hanging pin 332 is configured to be movably and extendably inserted into the corresponding one of the cross beams 331 and to extend through the corresponding one of the cross beams 331. A middle-lower portion of each hanging pin 332 is located within the corresponding one of the cross beams 331, and is sleevedly provided with an elastic component 333, while a middle-upper portion of each hanging pin 332 is configured to protrude from a top surface of the corresponding one of cross beams 331. A boss 3321 is formed at a junction between the middle-lower portion and the middle-upper portion of each hanging pin 332. A first end of the elastic component 333 is configured to abut against the boss 3321 of the hanging pin 332, and a second end of the elastic component 333 is configured to abut against a bottom surface of the cross beam 331. A limiting part 334 is provided at an end of each hanging pin 332 located outside the bottom surface of the corresponding one of the cross beams 331.

In this embodiment, an interior of the cross beam 331 has a hollow structure, and the elastic component 333 is a spring. By providing the elastic component 333, adjustment of the hanging pin 332 is facilitated, and after the first handle 61 is removed, the elastic component 333 is capable of driving the hanging pin 332 to return to its original position, thereby facilitating subsequent use. The limiting part 334 is a screw. A diameter of a head of the screw is slightly larger than a diameter of the hanging pin 332. The provision of the limiting part 334 limits movement of the hanging pin 332, thereby preventing the hanging pin 332 from disengaging from the cross beam 331 under the action of the elastic component 333.

In an embodiment, a side wall of the middle-upper portion of each hanging pin 332 is configured to be recessed inward to form an hourglass shape.

In this embodiment, the hourglass-shaped hanging pin 332 enables the first handle 61 to be more securely hooked, thereby preventing disengagement due to vibration or other external disturbances.

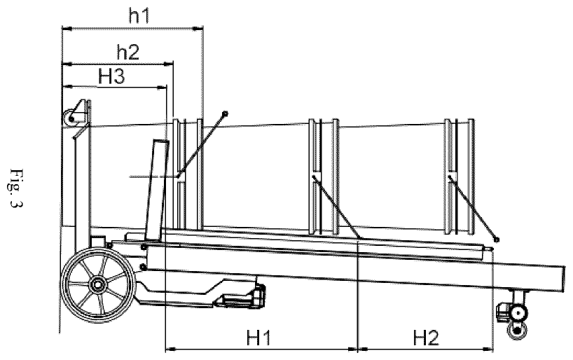

As shown in FIG. 3, an outer wall surface of the bucket 6 is in contact with the lifting arm 32 of the electric lifting device, and at this time, the lifting arm 32 has not yet started a lifting operation. In this embodiment, the electric lifting device is used to handle a bucket having a height h1 of 370 mm and a shoulder height h2 of 293 mm, where the shoulder height refers to a height between a bottom surface of the flange 62 of the bucket 6 and a bottom surface of the bucket 6. A height difference H1 between a top end of one of the two hanging pins 332 on the second cross beam 331 and a top surface of the lifting arm 32 at a position below a root portion of the first handle of the bucket is 510±20 mm. A height difference H2 between a top end of one of the two hanging pins 332 on the first cross beam 331 and the top end of the one of the two hanging pins 332 on the second cross beam 331 is 355±20 mm.

A height H3 between the top surface of the lifting arm 32 at a position below the root portion of the first handle 61 and the ground is 265±20 mm.

In this embodiment, a vertical height between an end of the lifting arm 32, which is away from the support column 2, and the ground is set lower than the shoulder height of the bucket 6. This facilitates insertion of the lifting arm 32 into the two sides of the bucket 6. Furthermore, after the lifting arm 32 lifts the bucket 6 off the ground, a downward pulling force is applied to the first handle 61 due to a weight of the bucket 6, thereby tightening the first handle 61 against the hanging pin 332, such that the upper bucket 6 is prevented from slipping off during transportation due to shaking or bumping.

Meanwhile, when transporting two stacked layers of the bucket 6, considering that the first handle 61 can be easily secured onto the hanging pin 332 in an initial state of the electric lifting device (with the lifting arm 32 at its lowest position), the height difference between the top end of the one of the two hanging pins on the second cross beam 331 and the top surface of the lifting arm 32 at a position below the root portion of the first handle 61 is set to 510 mm. This configuration allows the first handle 61 of the second-layer bucket 6 to be easily secured onto the hanging pin 332 without lifting the bucket 6.

When transporting three stacked layers of the bucket 6, the height difference between the top end of the one of the two hanging pins on the first cross beam 331 and the top end of the one of the two hanging pins 332 on the second cross beam 331 is set to 355 mm. This configuration allows the first handle of the third-layer bucket 6 to be easily secured manually onto the hanging pin without lifting the bucket 6. After the lifting arm is raised and comes into contact with the shoulder of the bucket, the bucket is lifted off the ground, during which the first handle 61 also moves downward relative to the hanging pin 332 into a tensioned state.

In some embodiments, depending on the specifications of the bucket, and based on the concepts of the present disclosure, the heights of the lifting arm 32 and the cross beams 331 can be correspondingly adjusted. Such modifications fall within the scope of the present disclosure.

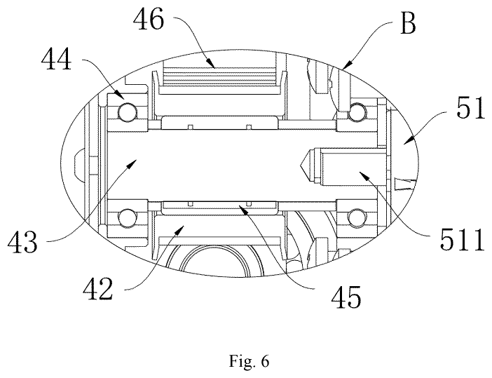

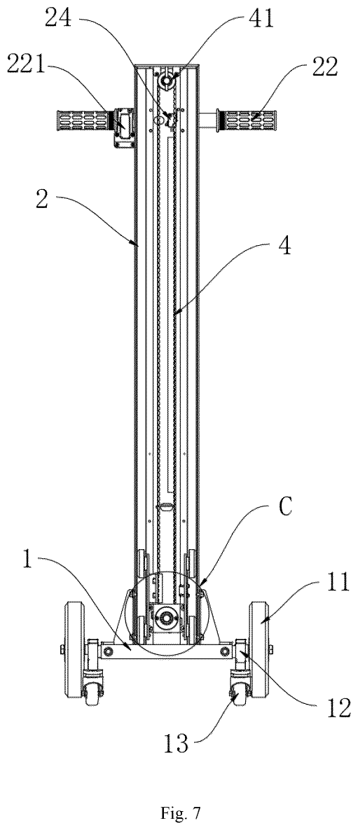

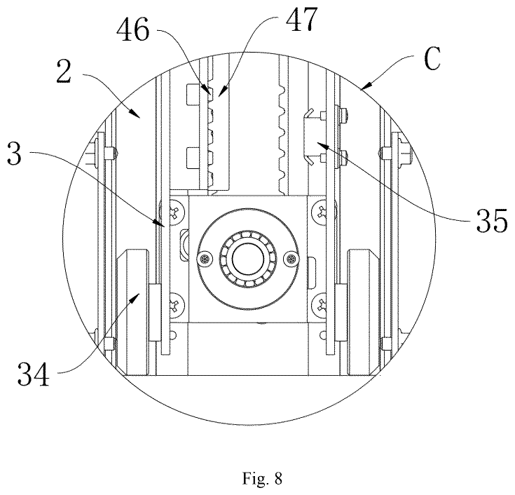

As shown in FIGS. 6-8, in an embodiment, the transmission assembly 4 includes a first drive wheel 41, a mounting bracket 411, a second drive wheel 42, a rotating shaft 43, and a transmission belt 46. The first drive wheel 41 is rotatably mounted on an inner wall at an upper end of the support column 2 through the mounting bracket 411. The second drive wheel 42 is sleevedly connected with the rotating shaft 43. Two ends of the rotating shaft 43 are rotatably mounted on an inner wall at a lower end of the support column 2. One of the two ends of the rotating shaft 43 is configured to extend through the support column 2 to be connected to the driving assembly 5. The first drive wheel 41 is drivably connected to the second drive wheel 42 via the transmission belt 46. The transmission belt 46 is fixedly connected to a portion of the sliding frame 3 extending into the support column 2.

In this embodiment, the two ends of the rotating shaft 43 are each rotatably mounted on the inner wall at the lower end of the support column 2 via a bearing 44. The provision of the bearing 44 allows the rotating shaft 43 to rotate more smoothly.

The transmission belt 46 is fixedly connected to the portion of the sliding frame 3 extending into the support column 2 via a fixing clamp plate 47. The fixing clamp plate 47 is fixedly connected to the sliding frame 3.

During operation, the driving assembly 5 drives the rotating shaft 43 to rotate, which in turn drives the second drive wheel 42 to rotate synchronously. Rotation of the second drive wheel 42 drives the transmission belt 46, thereby driving the fixing clamp plate 47 and the sliding frame 3 to slide within the sliding grooves 21. When the transmission belt 46 drives the sliding frame 3 to move toward the upper end of the support column 2, the bucket 6 is lifted via the lifting arm 32. Conversely, when the transmission belt 46 drives the sliding frame 3 to move toward the lower end of the support column 2, the bucket 6 is lowered via the lifting arm 32.

In an embodiment, a one-way bearing 45 is provided between the second drive wheel 42 and the rotating shaft 43.

In this embodiment, by providing the one-way bearing 45, when the sliding frame 3 is required to move toward the upper end of the support column 2, the one-way bearing 45 is engaged, such that the rotating shaft 43 drives the second drive wheel 42 to rotate, and the second drive wheel 42 drives the transmission belt 46. Conversely, the second drive wheel 42 is not driven to rotate.

In an embodiment, the driving assembly 5 includes a motor 51, a housing 52, and a battery 53. The motor 51 is mounted to the support column 2. An output shaft 511 of the motor 51 is connected to the rotating shaft 43. The housing 52 is configured to cover the motor 51. The battery 53 is engaged with an outer wall of the housing 52. The battery 53 is electrically connected to the motor 51.

In this embodiment, the battery 53 is a lithium battery. The housing 52 is provided to protect the motor 51. The battery 53 is engaged with the outer wall of the housing 52, thereby enabling convenient replacement of the battery 53.

During operation, the motor 51 drives the rotating shaft 43 to rotate via the output shaft 511. Rotation of the rotating shaft 43 causes the second drive wheel 42 to rotate synchronously. Rotation of the second drive wheel 42 drives the transmission belt 46, thereby driving the fixing clamp plate 47 and the sliding frame 3 to slide within the sliding grooves 21.

In an embodiment, a limit switch 24 is provided on an inner wall of the support column 2 adjacent to a top of the support column 2. A limit contact piece 35 is provided on a side of the sliding frame 3 extending into the support column 2. When the limit contact piece 35 is in contact with the limit switch 24, the sliding frame 3 is configured to be stopped from sliding toward the top of the support column 2.

In this embodiment, by mounting the limit contact piece 35 on the sliding frame 3 and the limit switch 24 on the inner wall of the support column 2 adjacent to the top of the support column 2, when the sliding frame 3 moves upward to the position of the limit switch 24, the limit contact piece 35 engages the limit switch 24, causing the limit switch 24 to open an upward traveling circuit, thereby immediately stopping the upward movement of the sliding frame 3.

In an embodiment, two ends of the sliding frame 3 extending into the support column 2 are each provided with at least two driven wheels 34.

In this embodiment, by providing the driven wheels 34, the sliding frame 3 can slide more smoothly, and the driven wheels 34 can cooperate with the support column 2 to limit the movement of the sliding frame 3, thereby preventing the sliding frame 3 from disengaging from the sliding grooves 21.

In an embodiment, two sides of the base 1 are each provided with a roller 11 and a support leg 12. A first end of the support leg 12 is fixedly connected to the base 1, and a second end of the support leg 12 is configured to extend toward a side of the support column 2 away from the driving assembly 5. The second end of the support leg 12 is provided with a swivel caster 13.

In this embodiment, the provision of the support legs 12 enhances the stability of the electric lifting device and prevents the electric lifting device from tipping over. In addition, by providing the swivel caster 13, directional control during transport is facilitated, thereby improving the overall maneuverability of the electric lifting device.

In an embodiment, a second handle 22 is mounted at the upper end of the support column 2, and is arranged on the same side of the support column 2 as the driving assembly 5. The second handle 22 is provided with an auxiliary pulley 23.

In this embodiment, by providing the second handle 22, the electric lifting device can be controlled during transport to be pushed or pulled. In addition, the auxiliary pulley 23 enables the support legs 12 to be lifted manually when loading onto a truck bed. When the auxiliary pulley 23 contacts a bottom surface of the truck bed, the electric lifting device can be raised and rolled into the truck bed, eliminating the need to lift the entire electric lifting device. This arrangement reduces labor and risk of falling, by providing the auxiliary pulley 23, loading is made easier and safer.

In an embodiment, a foot-operated bracket 14 is provided on the base 1 adjacent to the driving assembly 5.

In this embodiment, after the bucket 6 is lifted off the ground by the lifting arm 32, a foot is braced against the foot-operated bracket 14 and the second handle 22 is actuated, such that the electric lifting device is tilted to a predetermined angle, thereby enabling the electric lifting device to be pushed.

In an embodiment, the second handle 22 is provided with a control button 221.

In this embodiment, the control button 221 integrates an upward button, a downward button and a pause button, and is configured to control a rotation direction of the motor 51, thereby controlling the lifting, lowering, and stopping operations of the electric lifting device.

Specifically, when the upward button is pressed, the motor 51 is driven to rotate (to cause the sliding frame 3 move upward), and the output shaft 511 of the motor 51 drives the rotating shaft 43 to rotate. At this time, the one-way bearing 45 is engaged, such that the rotating shaft 43 drives the second drive wheel 42 to rotate synchronously, and the second drive wheel 42 drives the transmission belt 46, thereby driving the sliding frame 3 to move upward. Correspondingly, the lifting arm 32 lifts the bucket 6 upward.

When the sliding frame 3 moves upward to the position of the limit switch 24, the limit contact piece 35 comes into contact with the limit switch 24, such that the limit switch 24 disconnects the upward traveling circuit, whereby the sliding frame 3 immediately stops moving upward.

When the downward button is pressed, the motor 51 is driven to rotate in a reverse direction (to cause the sliding frame 3 to move downward). Although the second drive wheel 42 is provided with the one-way bearing 45, weight of the sliding frame 3, attached components or the bucket 6 drives the second drive wheel 42 to rotate synchronously, such that the sliding frame 3 slowly moves downward. When the sliding frame 3 moves downward to the base 1, the sliding frame 3 is forcibly limited. At this time, in the absence of the weight of the sliding frame 3, the attached components or the bucket 6, the one-way bearing 45 no longer restricts the rotating shaft 43, causing the motor 51 to slip. Upon releasing the control button, the motor 51 stops operating.

When the control button is released during upward or downward movement, the motor 51 also stops operating. The electric lifting device of the present disclosure is provided with an electronic braking function. After the control button is released during operation, the sliding frame 3 is held at a stopped position and does not continue to slide due to gravity or inertia.

Described above are merely preferred embodiments of the present disclosure, and are not intended to limit the scope of the present disclosure. It should be understood that various modifications, changes and replacements made by those skilled in the art without departing from the spirit of the disclosure shall fall within the scope of the present disclosure defined by the appended claims.

What is claimed is:

1. An electric lifting device, comprising:
a base;
a support column;
a sliding frame;
a lifting arm;
an auxiliary frame;
a transmission assembly; and
a driving assembly;
wherein the support column is configured to be hollow, and is vertically mounted on the base; a side of the support column is provided with a sliding groove extending along a length direction of the support column; and the sliding groove communicates with an interior of the support column;
the sliding frame is configured to be partially embedded within the sliding groove and extend into the interior of the support column; and the sliding frame is configured to slide along the sliding groove;
the lifting arm is mounted to the sliding frame;
the auxiliary frame is mounted on the sliding frame, and is arranged parallel to the support column; the auxiliary frame is provided with a plurality of hanging pins; and the plurality of hanging pins are extendable;
the transmission assembly is provided at the support column; and
the driving assembly is provided on a side of the support column away from the lifting arm, and is configured to drive the sliding frame to slide through the transmission assembly.

2. The electric lifting device of claim 1, wherein the auxiliary frame is provided with a plurality of cross beams arranged spaced apart from each other;
each of the plurality of hanging pins is movably inserted in a corresponding one of the plurality of cross beams, and is configured to extend through the corresponding one of the plurality of cross beams;
a middle-lower portion of each of the plurality of hanging pins is located within the corresponding one of the plurality of cross beams, and is sleevedly provided with an elastic component;
a middle-upper portion of each of the plurality of hanging pins is configured to protrude from a top surface of the corresponding one of the plurality of cross beams; and
a first end of the elastic component is connected to a side wall of a corresponding one of the plurality of hanging pins, and a second end of the elastic component is connected to an inner wall of the corresponding one of the plurality of cross beams.

3. The electric lifting device of claim 2, wherein a boss is formed at a junction between the middle-lower portion and the middle-upper portion of each of the plurality of hanging pins;
the first end of the elastic component is configured to abut against the boss, and the second end of the elastic component is configured to abut against a bottom surface of the corresponding one of the plurality of cross beams; and
a limiting part is provided at an end of each of the plurality of hanging pins located outside the bottom surface of the corresponding one of the plurality of cross beams.

4. The electric lifting device of claim 3, wherein a side wall of the middle-upper portion of each of the plurality of hanging pins is configured to be recessed inward to form an hourglass shape.

5. The electric lifting device of claim 2, wherein the number of the plurality of cross beams is two; the number of the plurality of hanging pins is two; two cross beams are arranged spaced apart from each other along a length direction of the auxiliary frame, and consist of a first cross beam and a second cross beam located below the first cross beam; and
a height difference between a top end of one of the two hanging pins on the second cross beam and a top surface of the lifting arm at a position below a root portion of a handle of a bucket is 510±20 mm.

6. The electric lifting device of claim 5, wherein a height difference between a top end of one of the two hanging pins on the first cross beam and the top end of the one of the two hanging pins on the second cross beam is 355±20 mm.

7. The electric lifting device of claim 1, wherein the transmission assembly comprises a first drive wheel, a mounting bracket, a second drive wheel, a rotating shaft and a transmission belt;
the first drive wheel is rotatably mounted on an inner wall at an upper end of the support column through the mounting bracket;
the second drive wheel is sleevedly connected with the rotating shaft;
two ends of the rotating shaft are rotatably mounted on an inner wall at a lower end of the support column;
one of the two ends of the rotating shaft is configured to extend through the support column to be connected to the driving assembly;
the first drive wheel is drivably connected to the second drive wheel through the transmission belt; and
the transmission belt is fixedly connected to a portion of the sliding frame extending into the support column.

8. The electric lifting device of claim 7, wherein a one-way bearing is provided between the second drive wheel and the rotating shaft.

9. The electric lifting device of claim 7, wherein the driving assembly comprises a motor, a housing and a battery;
the motor is mounted to the support column;
an output shaft of the motor is connected to the rotating shaft;
the housing is configured to cover the motor;
the battery is engaged with an outer wall of the housing; and
the battery is electrically connected to the motor.

10. The electric lifting device of claim 1, wherein a limit switch is provided on an inner wall of the support column adjacent to a top of the support column;
a limit contact piece is provided on a side of the sliding frame extending into the support column; and
in response to a case that the limit contact piece is in contact with the limit switch, the sliding frame is configured to be stopped from sliding toward the top of the support column.
